(19) United States
(12) Patent Application Publication
(10) Pub. No.: US 2024/0314552 A1
(43) Pub. Date: Sep. 19, 2024

(54) APPLICATION REGISTRATION WITH A NETWORK

(71) Applicant: Lenovo (Singapore) Pte. Ltd., New Tech Park (SG)

(72) Inventors: Andreas Kunz, Ladenburg (DE); Sheeba Backia Mary Baskaran, Friedrichsdorf (DE)

(21) Appl. No.: 18/257,732

(22) PCT Filed: Nov. 18, 2021
(86) PCT No.: PCT/IB2021/060715

§ 371 Date: Jun. 15, 2023

Related U.S. Application Data
(60) Provisional application No. 63/125,819, filed on Dec. 15, 2020.

(51) Int. Cl. H04W 12/041; H04W 60/00

(52) U.S. Cl. CPC H04W 12/041; H04W 60/00

(57) ABSTRACT

Apparatuses, methods, and systems are disclosed for application registration with a network. One method includes transmitting an application registration request to a network device. The application registration request includes a client identifier, an authentication code, a routing identifier, or a combination thereof. The method includes receiving a response from the network device. The response corresponds to the application registration request.

### CROSS-REFERENCE TO RELATED APPLICATIONS

This application claims priority to U.S. Patent Application Ser. No. 63/125,819 entitled “APPARATUSES, METHODS, AND SYSTEMS FOR ROUTING TO A NETWORK EXPOSURE FUNCTION AND KEY SEPARATION” and filed on Dec. 15, 2020 for Andreas Kunz, which is incorporated herein by reference in its entirety.

### FIELD

The subject matter disclosed herein relates generally to wireless communications and more particularly relates to application registration with a network.

### BACKGROUND

In certain wireless communications networks, keys may be used for communication. In such networks, different keys may be used at different times.

### BRIEF SUMMARY

Methods for application registration with a network are disclosed. Apparatuses and systems also perform the functions of the methods. One embodiment of a method includes transmitting, from a user equipment, an application registration request to a network device. The application registration request includes a client identifier, an authentication code, a routing identifier, or a combination thereof. In some embodiments, the method includes receiving a response from the network device. The response corresponds to the application registration request.

One apparatus for application registration with a network includes a user equipment. In some embodiments, the apparatus includes a transmitter that transmits an application registration request to a network device. The application registration request includes a client identifier, an authentication code, a routing identifier, or a combination thereof. In various embodiments, the apparatus includes a receiver that receives a response from the network device. The response corresponds to the application registration request.

Another embodiment of a method for application registration with a network includes receiving, at a first network device, an application registration request from a user equipment. The application registration request includes a client identifier, an authentication code, a routing identifier, or a combination thereof. In some embodiments, the method includes transmitting a response to the user equipment. The response corresponds to the application registration request.

Another apparatus for application registration with a network includes a first network device. In some embodiments, the apparatus includes a receiver that receives an application registration request from a user equipment. The application registration request includes a client identifier, an authentication code, a routing identifier, or a combination thereof. In various embodiments, the apparatus includes a transmitter that transmits a response to the user equipment. The response corresponds to the application registration request.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for application registration with a network;

FIG. 2 is a schematic block diagram illustrating one embodiment of an apparatus that may be used for application registration with a network;

FIG. 3 is a schematic block diagram illustrating one embodiment of an apparatus that may be used for application registration with a network;

FIG. 4 is a schematic block diagram illustrating one embodiment of a system for authentication and authorization with an edge data network:

FIG. 5 is a schematic block diagram illustrating another embodiment of a system for authentication and authorization with an edge data network:

FIG. 6 is a flow chart diagram illustrating one embodiment of a method for application registration with a network; and

FIG. 7 is a flow chart diagram illustrating another embodiment of a method for application registration with a network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

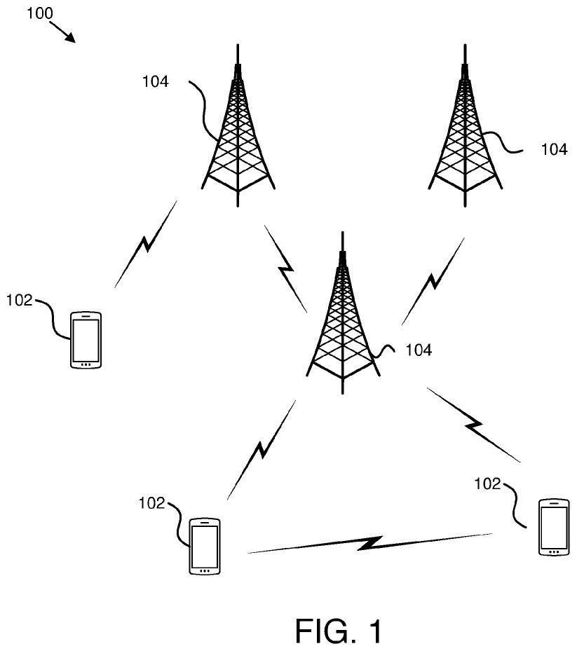

FIG. 1 depicts an embodiment of a wireless communication system 100 for application registration with a network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may transmit an application registration request to a network device. The application registration request includes a client identifier, an authentication code, a routing identifier, or a combination thereof. In some embodiments, the remote unit 102 may receive a response from the network device. The response corresponds to the application registration request. Accordingly, the remote unit 102 may be used for application registration with a network.

In certain embodiments, a network unit 104 may receive an application registration request from a user equipment. The application registration request includes a client identifier, an authentication code, a routing identifier, or a combination thereof. In some embodiments, the network unit 104 may transmit a response to the user equipment. The response corresponds to the application registration request. Accordingly, the network unit 104 may be used for application registration with a network.

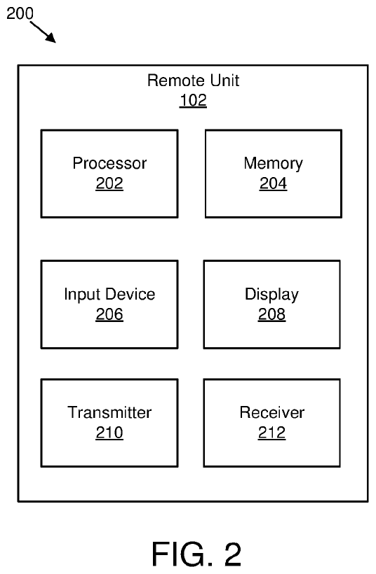

FIG. 2 depicts one embodiment of an apparatus 200 that may be used for application registration with a network. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 may transmit an application registration request to a network device. The application registration request includes a client identifier, an authentication code, a routing identifier, or a combination thereof. In various embodiments, the receiver 212 receives a response from the network device. The response corresponds to the application registration request.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

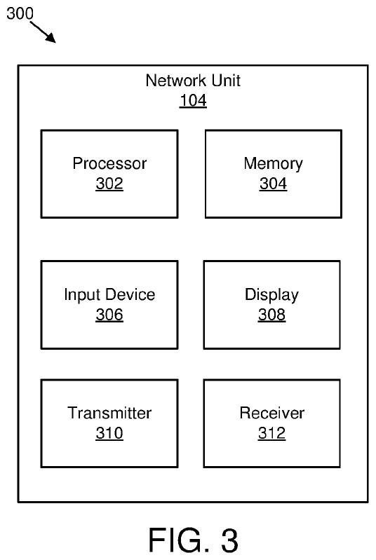

FIG. 3 depicts one embodiment of an apparatus 300 that may be used for application registration with a network. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives an application registration request from a user equipment. The application registration request includes a client identifier, an authentication code, a routing identifier, or a combination thereof. In various embodiments, the transmitter 310 transmits a response to the user equipment. The response corresponds to the application registration request.

In certain embodiments, if multiple edge enabler clients (“EECS”) access different services on different mobile edge computing (“MEC”) functions, the keys for those may need to be different and identified. To distinguish separate keys for different MEC functions (e.g., edge configuration server (“ECS”), edge enabler server (“EES”), and edge application server (“EAS”)), a key identifier (“ID”) in a key derivation function (“KDF”) for deriving a respective key and to identify the key with this ID.

In some embodiments, a key ID may be any unique number to identify the key or may be the ID of a MEC function (e.g., EEC ID, EES ID, EAS ID). In various embodiment, only an EEC ID may be used as additional input to all key derivations for keys K_{ECS}, K_{EES}, and K_{EAS}.

In certain embodiments, for routing issue towards a network exposure function (“NEF”), a NEF routing ID may be included in a response to an access and mobility management function (“AMF”) at the time of the AMF ID registration. The NEF routing ID may be provisioned to a user equipment (“UE”) in a non-access stratum (“NAS”) message and used for the ECS registration procedure. The routing ID may be a network access identifier (“NAI”) or a uniform resource identifier (“URI”) pointing to a specific NEF or NEF instance or may be an internet protocol (“IP”) address and/or port number of the NEF or any routable identifier.

In a first embodiment, there may be NEF routing and key separation with different key IDs. In such an embodiment, a K_{AMF} is generated during a primary authentication. The network function that receives a registration request may query a previous network function for authentication and a key for setting up an IPsec security association (“SA”). Messages may be protected with a message authentication code for integrity (“MAC-I”), which may also be used to authenticate the UE.

In some embodiments, a preferred ECS deployment scenario, if the ECS is located in a serving network or hosted by a 3rd party service provider, since the services are to be hosted close to the UE's access point of attachment, may be to achieve an efficient service delivery through the reduced end-to-end latency and load on the transport network. For roaming scenarios where the ECS is only located in a home public land mobile network (“HPLMN”), while the UE is in a visiting public land mobile network (“VPLMN”), the K_{ECS} is then derived from the VPLMN K_{AMF}.

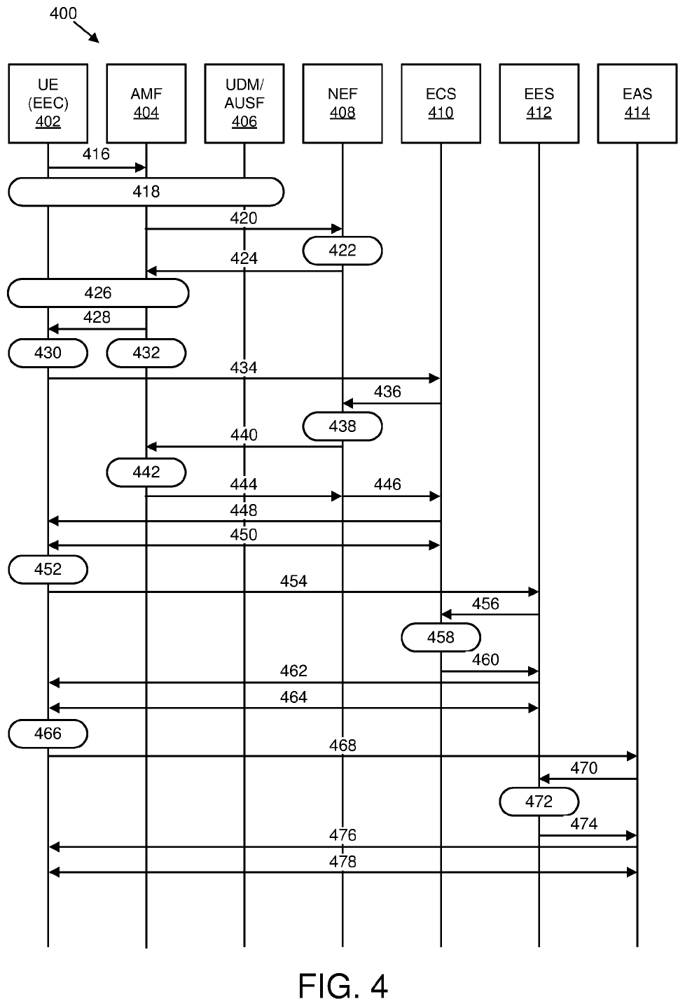

FIG. 4 is a schematic block diagram illustrating one embodiment of a system 400 for authentication and authorization with an edge data network. The system 400 includes a UE 402 (e.g., including one or more EECS), an AMF 404, a UDM/AUSF 406, an NEF 408, an ECS 410, an EES 412, and an EAS 414. It should be noted that each communication described herein may include one or more messages.

In a first communication 416 and/or a second communication 418, the UE 402 performs normal primary authentication and registration to the network. The UE 402 is MEC capable and may indicate this in the MEC capabilities to the AMF 404 during a registration procedure (e.g., via an NAS registration request).

In a third communication 420, the AMF 404 sends an identifier registration request to the NEF 408 including an EEC ID (or multiple EEC IDs).

It should be noted that the EEC ID is configured in the UE 402 and provisioned to the AMF 404, configured in subscriber data and provisioned to the UE 402 after protocol data unit (“PDU”) session establishment, or both. In various embodiments, NEF 408 selection may be concluded in SA2.

The NEF 408 stores 422 the EEC ID and an AMF ID together and assigns an NEF routing ID, which is an URI or NAI of the NEF 408, reachable for the ECS 410.

In a fourth communication 424, the NEF 408 acknowledges an identifier registration and provides the NEF routing ID to the AMF 404. The NEF 408 may subscribe to AMF 404 changes.

In a fifth communication 426 and/or a sixth communication 428, the UE 402 establishes a PDU session for IP connectivity. The AMF 404 then concludes the registration procedure and provides the NEF routing ID to the UE 402 (e.g., via an NAS registration accept).

If the UE 402 is MEC capable, then the UE 402 and the AMF 404 derive 430, 432 a key K_{ECS} for authentication with the ECS 410 from the AMF 404 key K_{AMF}. The AMF 404 uses the EEC ID as an input to the KDF to generate a different K_{ECS} if the UE 402 is using services of different ECSs. The EEC ID is then used as a key identifier and stored together with the K_{ECS}. The UE 402 and AMF 404 initialize the CounterECS when the K_{ECS} is derived and the counter is stored for the lifetime of the K_{ECS}.

In a seventh communication 434, the UE 402 sends an application registration request with a message authentication code (“MAC”) for integrity (“MAC-I”) (e.g., MAC-I_{ECS}), NEF routing ID, EES ID, and/or an EEC ID to the ECS 410. The MAC-I_{ECS} may be computed in a predefined manner. The MAC-I_{ECS} may be based on a payload of an application registration request, which may form input application registration request data, a counter of the ECS messages (e.g., CounterECS), and a key K_{ECS} to the KDF. The MAC-I_{ECS} may be identified with the 128 least significant bits of the output of the KDF. The UE 402 monotonically increments CounterECS for each additional calculated MAC-I_{ECS}.

In an eighth communication 436, the UE 402 is not authenticated at the ECS 410 and the ECS 410 sends a key request including the application registration request with the MAC-I_{ECS} to the NEF 408, which is identified by the NEF routing ID. The NEF 408 selection may be specified and the ECS 410 may determine IP addresses and/or ports of the NEF 408 by performing a domain name service (“DNS:) query using a generic public subscription identifier (“GPSI”), or by using a locally configured NEF identifier and/or address. The ECS 410 stores the EES ID to select the right profile at a later request from the EES 412.

The NEF 408 authorizes 438 the request from the ECS 410 and identifies the AMF ID based on the EEC ID. The NEF 408 stores the contact of the ECS 410 (e.g., IP address, source NAI of the ECS 410, and so forth) with the EEC ID to route the answer from the AMF 404 back to the ECS 410.

In a ninth communication 440, the NEF 408 forwards the key request including the application registration request with the MAC-I_{ECS} as well as the EEC ID to the AMF 404.

The AMF 404 verifies 442 the MAC-I_{ECS} of the application registration request. It selects the key K_{ECS} based on the EEC ID and computes with the key K_{ECS} the MAC-I over the application registration request payload in the similar way as the UE 402 and compares the result with the MAC-I_{ECS} included in the message. If both are identical, the message may be authenticated to be sent by the UE 402, and the AMF 404 monotonically increments CounterECS.

In a tenth communication 444 and an eleventh communication 446, the AMF 404 sends a key response to the ECS 410, including the result of the authentication as well as the K_{ECS}.

In a twelfth communication 448, based on the authentication result, the ECS 410 decides whether to accept or to reject the application registration request from the UE 402. The ECS 410 sends the application registration response message to the UE 402 including the authentication result and protects the message with a MAC-I_{ECS} based on the received key K_{ECS} in a similar way as the UE 402 protected the payload of the message in step 424.

In a thirteenth communication 450, the UE 402 verifies the MAC-I_{ECS} and, if an authentication result and verification of the message are successful, then the UE 402 establishes an IPsec SA between the UE 402 and the ECS 410 by using the ECS 410 key K_{ECS}. All messages may be confidentiality and integrity protected by the IPsec tunnel.

The UE 402 derives 452 the key K_{EES} from the key K_{ECS} using a MEC key distinguisher flag and the EES ID as input to the KDF. The EES ID is then used as a key identifier and stored together with the K_{EES}, if the UE 402 is using services of different EESs. The EES ID may be unique enough to identify a UE 402 at the ECS 410 in step 458.

In a fourteenth communication 454, the UE 402 sends an application registration request with a MAC-I_{EES}. EAS ID, and the EES ID to the EES 412. The MAC-I_{EES} is computed based on the payload of the application registration request, which form the input application registration request data, and the key K_{EES} to the KDF. The MAC-I_{EES} is identified with the 128 least significant bits of the output of the KDF.

In a fifteenth communication 456, the UE 402 is not authenticated at the EES 412 and the EES 412 sends a key request to the ECS 410. The selection of the ECS 410 may be based on the EES ID. The EES 410 stores the EAS ID to select the right profile at a later request from the EAS 414.

The ECS 410 identifies 458 the UE 402 based on the EES ID and derives the key K_{EES} in a similar way as the UE 402 in step 452. The ECS 410 verifies the MAC-I_{EES} of the application registration request. It computes with the key K_{EES} the MAC-I over the application registration request payload in the similar way as the UE 402 and compares the result with the MAC-I_{EES} included in message. If both are identical, the message may be authenticated to be sent by the UE 402.

In a sixteenth communication 460, the ECS 410 sends a key request response to the EES 412, including the result of the authentication as well as the K_{EES}.

In a seventeenth communication 462, based on the authentication result, the EES 412 decides whether to accept or to reject the application registration request from the UE 402. The EES 412 sends the application registration response message to the UE 402 including the authentication result and protects the message with a MAC-I_{EES} based on the received key K_{EES} in a similar way as the UE 402 protected the payload of the message in step 442.

In an eighteenth communication 464, the UE 402 verifies the MAC-I_{EES} and, if authentication result and verification of the message are successful, then the UE 402 establishes an IPsec SA between the UE 402 and EES 412 by using the EES 412 key K_{EES}. All messages are now confidentiality and integrity protected by the IPsec tunnel.

The UE 402 derives 466 the key K_{EAS} from the key K_{EES} using a MEC key distinguisher flag and the EAS ID as input to the KDF. The EAS ID is then used as a key identifier and stored together with the K_{EAS}, if the UE 402 is using services of different EASs. The EAS ID must be unique enough to identify a UE 402 at the EES 412 in step 472.

In a nineteenth communication 468, the UE 402 sends an application registration request with a MAC-I_{EAS} and the EAS ID to the EAS 414. The MAC-I_{EAS} is computed based on the payload of the application registration request, which forms the input application registration request data, and the key K_{EAS} to the KDF. The MAC-I_{EAS} is identified with the 128 least significant bits of the output of the KDF.

In a twentieth communication 470, the UE 402 is not authenticated at the EAS 414 and the EAS 414 sends a key request to the EES 412. The selection of the EES 412 may be based on the EAS ID.

The EES 412 identifies 472 the UE 402 based on the EAS ID and derives the key K_{EAS} in a similar way as the UE 402 in step 466. The EES 412 verifies the MAC-I_{EAS} of the application registration request. It computes with the key K_{EAS} the MAC-I over the application registration request payload in the similar way as the UE 402 and compares the result with the MAC-I_{EAS} included in the message. If both are identical, the message may be authenticated to be sent by the UE 402.

In a twenty-first communication 474, the EES 412 sends a key request response to the EAS 414, including the result of the authentication as well as the K_{EAS}.

In a twenty-second communication 476, based on the authentication result, the EAS 414 decides whether to accept or to reject the application registration request from the UE 402. The EAS 414 sends the application registration response message to the UE 402 including the authentication result and protects the message with a MAC-I_{EAS} based on the received key K_{EAS} in a similar way that the UE 402 protected the payload of the message in step 422.

In a twenty-third communication 478, the UE 402 verifies the MAC-I_{EAS} and, if an authentication result and verification of the message are successful, then the UE 402 establishes an IPsec SA between the UE 402 and the EAS 414 by using the EAS 414 key K_{EAS}. All messages may then be confidentiality and integrity protected by the IPsec tunnel.

In a second embodiment, there may be NEF routing and key separation with EEC IDs. The second embodiment may be based on the K_{AMF} generated during the primary authentication. The network function that receives a registration request is querying the previous network function for authentication and the key for setting up an IPsec SA. Messages may be protected with a MAC-I, which may be used to authenticate a UE.

In certain embodiments, an ECS deployment scenario may, if the ECS is located in the serving network or hosted by a 3rd party service provider, since the services are to be hosted close to the UE's access point of attachment, achieve an efficient service delivery through the reduced end-to-end latency and load on the transport network. For roaming scenarios where the ECS is only located in the HPLMN while the UE is in a VPLMN, the K_{ECS} may be derived from the VPLMN K_{AMF}.

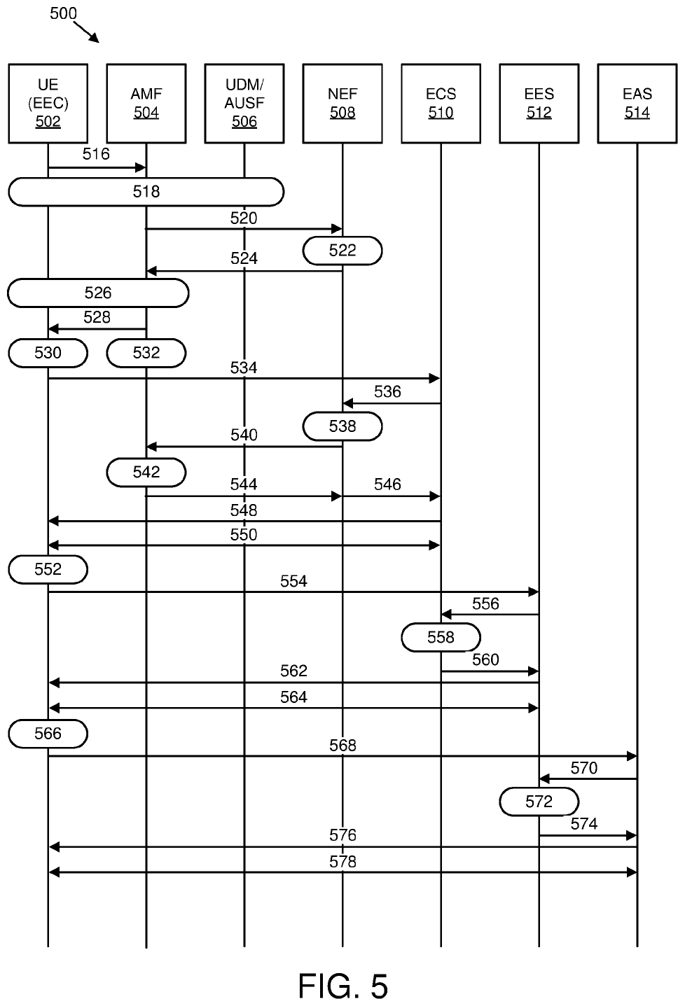

FIG. 5 is a schematic block diagram illustrating another embodiment of a system 500 for authentication and authorization with an edge data network. The system 400 includes a UE 502 (e.g., including one or more EECS), an AMF 504, a UDM/AUSF 506, an NEF 508, an ECS 510, an EES 512, and an EAS 514. It should be noted that each communication described herein may include one or more messages.

In a first communication 516 and/or a second communication 518, the UE 502 performs normal primary authentication and registration with a network. The UE 502 is MEC capable and may indicate this in the MEC capabilities to the AMF 504 during the registration procedure.

In a third communication 520, the AMF 504 sends an identifier registration request to the NEF 508 including the EEC ID.

It may be assumed that the EEC ID is configured in the UE 502 and provisioned in steps 516 and/or 518 to the AMF 504, configured in the subscriber data and provisioned to the UE 502 after PDU session establishment, or both. The solution on NEF selection may be concluded in SA2.

The NEF 508 stores 522 the EEC ID and the AMF ID together and assigns a NEF routing ID, which is a URI or NAI of the NEF 508, reachable for the ECS 510.

In a fourth communication 524, the NEF 508 acknowledges the identifier registration and provides the NEF routing ID to the AMF 504. The NEF 508 may subscribe to AMF 504 changes.

In a fifth communication 526 and/or a sixth communication 528, the UE 502 establishes a PDU session for IP connectivity. The AMF 504 then concludes the registration procedure and provides the NEF routing ID to the UE 502.

If the UE 502 is MEC capable, then the UE 502 and the AMF 504 derive 530, 532 a key K_{ECS} for authentication with the ECS 510 from the AMF 504 key K_{AMF}. The AMF 504 uses the EEC ID as an input to the KDF to generate a different K_{ECS} if the UE 502 is using services of different ECSs. The EEC ID is then used as a key identifier and stored together with the K_{ECS}. The UE 502 and AMF 504 initialize the CounterECS if the K_{ECS} is derived and the counter is stored for the lifetime of the K_{ECS}.

In a seventh communication 534, the UE 502 sends an application registration request with a MAC-I_{ECS}, NEF routing ID, and/or an EEC ID to the ECS 510. The MAC-I_{ECS} is computed based on predetermined methods. The MAC-I_{ECS} may be based on a payload of the application registration request, which forms the input application registration request data, a counter of the ECS 510 messages CounterECS, and the key K_{ECS} to the KDF. The MAC-I_{ECS} is identified with the 128 least significant bits of the output of the KDF. The UE 502 monotonically increments CounterECS for each additional calculated MAC-I_{ECS}.

In an eighth communication 536, the UE 502 is not authenticated at the ECS 510 and the ECS 510 sends a key request including the application registration request with the MAC-I_{ECS} to the NEF 508, which is identified by the NEF routing ID. The NEF 508 selection may be specified and the ECS 510 may determine the IP addresses and/or ports of the NEF 508 by performing a DNS query using the GPSI, or by using a locally configured NEF identifier and/or address. The ECS 510 stores the EEC ID to select the right profile at a later request from the EES 512.

The NEF 508 authorizes 538 the request from the ECS 510 and identifies the AMF ID based on the EEC ID. The NEF 508 stores the contact of the ECS 510 (e.g., IP address, source NAI of the ECS 510, etc.) with the EEC ID to route the answer from the AMF 504 back to the ECS 510.

In a ninth communication 540, the NEF 508 forwards the key request including the application registration request with the MAC-I_{ECS} as well as the EEC ID to the AMF 504.

The AMF 504 verifies 542 the MAC-I_{ECS} of the application registration request. It selects the key K_{ECS} based on the EEC ID and computes with the key K_{ECS} the MAC-I over the application registration request payload in the similar way as the UE 502 and compares the result with the MAC-I_{ECS} included in the message. If both are identical, the message may be authenticated to be sent by the UE 502, and the AMF 504 monotonically increments CounterECS.

In a tenth communication 544 and/or an eleventh communication 546, the AMF 504 sends a key response to the ECS 510, including the result of the authentication as well as the K_{ECS}.

In a twelfth communication 548, based on the authentication result, the ECS 510 decides whether to accept or to reject the application registration request from the UE 502. The ECS 510 sends the application registration response message to the UE 502 including the authentication result and protects the message with a MAC-I_{ECS} based on the received key K_{ECS} in a similar way that the UE 502 protected the payload of the message in step 524.

In a thirteenth communication 550, the UE 502 verifies the MAC-I_{ECS} and, if authentication result and verification of the message are successful, then the UE 502 establishes an IPsec SA between the UE 502 and the ECS 510 by using the ECS 510 key K_{ECS}. All messages may be confidentiality and integrity protected by the IPsec tunnel.

The UE 502 derives 552 the key K_{EES} from the key K_{ECS} using a MEC key distinguisher flag and the EEC ID as input to the KDF. The EEC ID is then used as a key identifier and stored together with the K_{EES}, if the UE 502 is using services of different EESs.

In a fourteenth communication 554, the UE 502 sends an application registration request with a MAC-I_{EES} and the EEC ID to the EES 512. The MAC-I_{EES} is computed based on the payload of the application registration request, which forms the input application registration request data, and the key K_{EES} to the KDF. The MAC-I_{EES} is identified with the 128 least significant bits of the output of the KDF.

In a fifteenth communication 556, the UE 502 is not authenticated at the EES 512 and the EES sends a key request to the ECS 510. The selection of the ECS 510 may be based on the EEC ID. The EES 512 stores the EEC ID to select the right profile at a later request from the EAS 514.

The ECS 510 identifies 558 the UE 502 based on the EEC ID and derives the key K_{EES} in a similar way as the UE 502 in step 552. The ECS 510 verifies the MAC-I_{EES} of the application registration request. It computes with the key K_{EES} the MAC-I over the application registration request payload in the similar way as the UE 502 and compares the result with the MAC-I_{EES} included in the message. If both are identical, the message may be authenticated to be sent by the UE 502.

In a sixteenth communication 560, the ECS 510 sends a key request response to the EES 512, including the result of the authentication as well as the K_{EES}.

In a seventeenth communication 562, based on the authentication result, the EES 512 decides whether to accept or to reject the application registration request from the UE 502. The EES 512 sends the application registration response message to the UE 502 including the authentication result and protects the message with a MAC-I_{EES} based on the received key K_{EES} in a similar way that the UE 502 protected the payload of the message in step 542.

In an eighteenth communication 564, the UE 502 verifies the MAC-I_{EES} and, if authentication result and verification of the message are successful, then the UE 502 establishes an IPsec SA between the UE 502 and EES 512 by using the EES 512 key K_{EES}. All messages may then be confidentiality and integrity protected by the IPsec tunnel.

The UE 502 derives 566 the key K_{EAS} from the key K_{EES} using a MEC key distinguisher flag and the EEC ID as input to the KDF. The EEC ID is then used as a key identifier and stored together with the K_{EAS}, if the UE 502 is using services of different EASs.

In a nineteenth communication 568, the UE 502 sends an application registration request with a MAC-I_{EAS} and the EEC ID to the EAS 514. The MAC-I_{EAS} is computed based on the payload of the application registration request, which forms the input application registration request data, and the key K_{EAS} to the KDF. The MAC-I_{EAS} is identified with the 128 least significant bits of the output of the KDF.

In a twentieth communication 570, the UE 502 is not authenticated at the EAS 514 and the EAS 514 sends a key request to the EES 512. The selection of the EES 514 may be based on the EEC ID.

The EES 512 identifies 572 the UE 502 based on the EEC ID and derives the key K_{EAS} in a similar way as the UE 502 in step 566. The EES 512 verifies the MAC-I_{EAS} of the application registration request. It computes with the key K_{EAS} the MAC-I over the application registration request payload in the similar way as the UE 502 and compares the result with the MAC-I_{EAS} included in message. If both are identical, the message may be authenticated to be sent by the UE 502.

In a twenty-first communication 574, the EES 512 sends a key request response to the EAS 514, including the result of the authentication as well as the K_{EAS}.

In a twenty-second communication 576, based on the authentication result, the EAS 514 decides whether to accept or to reject the application registration request from the UE 502. The EAS 514 sends the application registration response message to the UE 502 including the authentication result and protects the message with a MAC-I_{EAS} based on the received key K_{EAS} in a similar way as the UE protected the payload of the message in step 522.

In a twenty-third communication 578, the UE 502 verifies the MAC-I_{EAS} and, if authentication result and verification of the message are successful, then the UE 502 establishes an IPsec SA between the UE 502 and EAS 514 by using the EAS 514 key K_{EAS}. All messages may then be confidentiality and integrity protected by the IPsec tunnel.

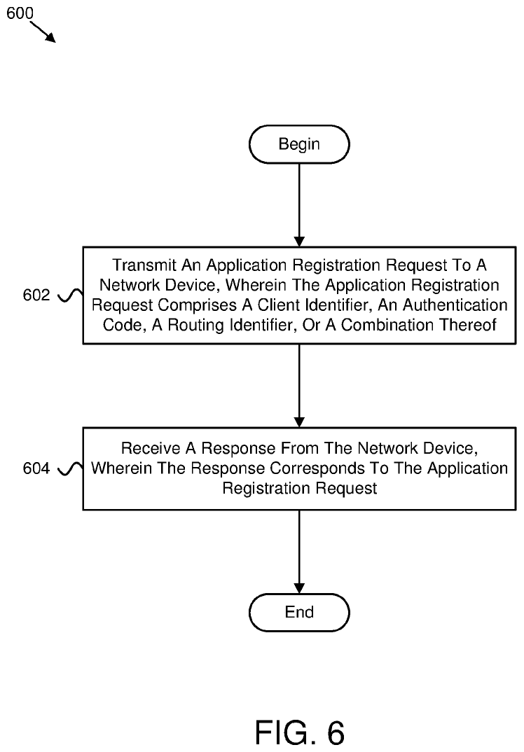

FIG. 6 is a flow chart diagram illustrating one embodiment of a method 600 for application registration with a network. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602 an application registration request to a network device. The application registration request includes a client identifier, an authentication code, a routing identifier, or a combination thereof. In some embodiments, the method 600 includes receiving 604 a response from the network device. The response corresponds to the application registration request.

In certain embodiments, the method 600 further comprises determining a key based on the client identifier. In some embodiments, the response is protected based on a key determined using the client identifier.

In various embodiments, the network device comprises an edge configuration server or an edge enabler server. In one embodiment, the network device initiates generation of a key based on the client identifier.

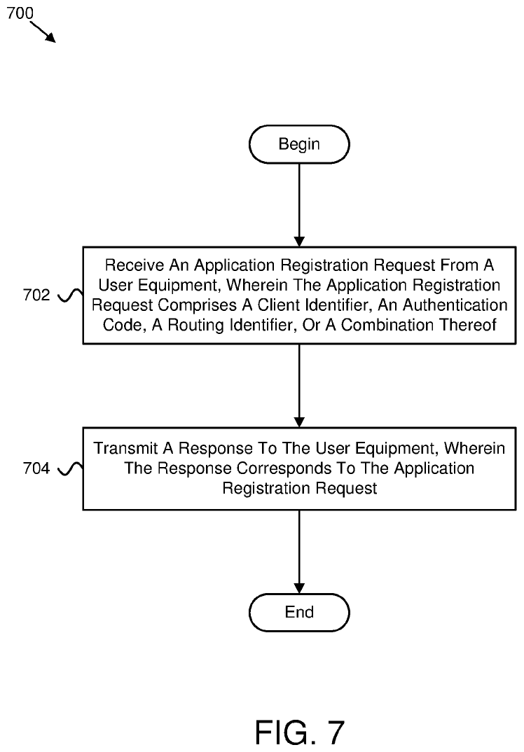

FIG. 7 is a flow chart diagram illustrating one embodiment of a method 700 for application registration with a network. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 an application registration request from a user equipment. The application registration request includes a client identifier, an authentication code, a routing identifier, or a combination thereof. In some embodiments, the method 700 includes transmitting 704 a response to the user equipment. The response corresponds to the application registration request.

In certain embodiments, the response is protected based on a key determined using the client identifier. In some embodiments, the first network device comprises an edge configuration server or an edge enabler server.

In various embodiments, the method 700 further comprises initiating generation of a key based on the client identifier. In one embodiment, the method 700 further comprises transmitting a key request to a second network device. In certain embodiments, the method 700 further comprises receiving a key response from the second network device, wherein the key response comprises a derived key.

In one embodiment, a method of a user equipment comprises: transmitting an application registration request to a network device, wherein the application registration request comprises a client identifier, an authentication code, a routing identifier, or a combination thereof; and receiving a response from the network device, wherein the response corresponds to the application registration request.

In certain embodiments, the method further comprises determining a key based on the client identifier.

In some embodiments, the response is protected based on a key determined using the client identifier.

In various embodiments, the network device comprises an edge configuration server or an edge enabler server.

In one embodiment, the network device initiates generation of a key based on the client identifier.

In one embodiment, an apparatus comprises a user equipment. The apparatus further comprises: a transmitter that transmits an application registration request to a network device, wherein the application registration request comprises a client identifier, an authentication code, a routing identifier, or a combination thereof, and a receiver that receives a response from the network device, wherein the response corresponds to the application registration request.

In certain embodiments, the apparatus further comprises a processor that determines a key based on the client identifier.

In some embodiments, the response is protected based on a key determined using the client identifier.

In various embodiments, the network device comprises an edge configuration server or an edge enabler server.

In one embodiment, the network device initiates generation of a key based on the client identifier.

In one embodiment, a method of a first network device comprises: receiving an application registration request from a user equipment, wherein the application registration request comprises a client identifier, an authentication code, a routing identifier, or a combination thereof; and transmitting a response to the user equipment, wherein the response corresponds to the application registration request.

In certain embodiments, the response is protected based on a key determined using the client identifier.

In some embodiments, the first network device comprises an edge configuration server or an edge enabler server.

In various embodiments, the method further comprises initiating generation of a key based on the client identifier.

In one embodiment, the method further comprises transmitting a key request to a second network device.

In certain embodiments, the method further comprises receiving a key response from the second network device, wherein the key response comprises a derived key.

In one embodiment, an apparatus comprises a first network device. The apparatus further comprises: a receiver that receives an application registration request from a user equipment, wherein the application registration request comprises a client identifier, an authentication code, a routing identifier, or a combination thereof; and a transmitter that transmits a response to the user equipment, wherein the response corresponds to the application registration request.

In certain embodiments, the response is protected based on a key determined using the client identifier.

In some embodiments, the first network device comprises an edge configuration server or an edge enabler server.

In various embodiments, the apparatus further comprises a processor that initiates generation of a key based on the client identifier.

In one embodiment, the transmitter transmits a key request to a second network device.

In certain embodiments, the receiver receives a key response from the second network device, wherein the key response comprises a derived key.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
transmitting an application registration request to a network device, wherein the application registration request comprises a client identifier, an authentication code, a routing identifier, or a combination thereof; and
receiving a response from the network device, wherein the response corresponds to the application registration request.

2. The method of claim 1, wherein the response is protected based on a key determined using the client identifier.

3. The method of claim 1, wherein the network device comprises an edge configuration server or an edge enabler server.

4. The method of claim 1, wherein the network device initiates generation of a key based on the client identifier.

5. An apparatus for wireless communication, comprising:
at least one memory; and
at least one processor coupled with the at least one memory and configured to cause the apparatus to:
transmit an application registration request to a network device, wherein the application registration request comprises a client identifier, an authentication code, a routing identifier, or a combination thereof; and
receive a response from the network device, wherein the response corresponds to the application registration request.

6. The apparatus of claim 5, wherein the processor is configured to cause the apparatus to determine a key based on the client identifier.

7. The apparatus of claim 5, wherein the response is protected based on a key determined using the client identifier.

8. The apparatus of claim 5, wherein the network device comprises an edge configuration server or an edge enabler server.

9. The apparatus of claim 5, wherein the network device initiates generation of a key based on the client identifier.

10. An apparatus for wireless communication, comprising:
at least one memory; and
at least one processor coupled with the at least one memory and configured to cause the apparatus to:
receive an application registration request from a user equipment (UE), wherein the application registration request comprises a client identifier, an authentication code, a routing identifier, or a combination thereof; and
transmit a response to the UE, wherein the response corresponds to the application registration request.

11. The apparatus of claim 10, wherein the response is protected based on a key determined using the client identifier.

12. The apparatus of claim 10, wherein the apparatus comprises an edge configuration server or an edge enabler server.

13. The apparatus of claim 10, wherein the at least one processor is configured to cause the apparatus to initiate generation of a key based on the client identifier.

14. The apparatus of claim 10, wherein the at least one processor is configured to cause the apparatus to transmit a key request to a second network device.

15. The apparatus of claim 14, wherein the at least one processor is configured to cause the apparatus to receive a key response from the second network device, wherein the key response comprises a derived key.

16. A processor for wireless communication, comprising:
at least one controller coupled with at least one memory and configured to cause the processor to:
transmit an application registration request to a network device, wherein the application registration request comprises a client identifier, an authentication code, a routing identifier, or a combination thereof; and
receive a response from the network device, wherein the response corresponds to the application registration request.

17. The processor of claim 16, wherein the at least one controller is configured to cause the processor to determine a key based on the client identifier.

18. The processor of claim 16, wherein the response is protected based on a key determined using the client identifier.

19. The processor of claim 16, wherein the network device comprises an edge configuration server or an edge enabler server.

20. The processor of claim 16, wherein the network device initiates generation of a key based on the client identifier.
